(19) United States
(12) Patent Application Publication
(10) Pub. No.: US 2018/0262432 A1
(43) Pub. Date: Sep. 13, 2018

(54) VERTICAL PACKET AGGREGATION USING A DISTRIBUTED NETWORK

(71) Applicant: VidScale, Inc., Cambridge, MA (US)

(72) Inventors: Gurer Ozen, Cambridge, MA (US); John Scharber, Sparks, NV (US)

(21) Appl. No.: 15/455,362

(22) Filed: Mar. 10, 2017

(51) Int. Cl. H04L 12/853; H04L 29/08; H04L 29/06; H04L 12/18; H04L 29/12

(52) U.S. Cl. CPC H04L 47/2416; H04L 67/2842; H04L 67/2804; H04L 61/2069; H04L 67/42; H04L 67/10; H04L 12/18; H04L 69/04

(57) ABSTRACT

A system and method for vertical packet aggregation in a client-server system comprising receiving packets from a plurality of clients, generating an aggregate packet having a copy of the payload of two or more of the packets received from different ones of the plurality of clients within a common buffer period, sending the generated aggregate packet to a remote server.

### BACKGROUND

As is known in the art, some client-server applications send/receive relatively small packets, and rely on those packets being propagated through a network with relatively low-latency. Such applications may be classified as low-latency, low-bandwidth applications.

As one example, some multiplayer online games use a client-server architecture where many clients (i.e., players) communicate with a centralized game server. Clients send a regular stream of small packets to the server that describe a player's actions, and the server sends a regular stream of small packets to each client that describe the aggregate game state. In a typical game, each game client may send/receive 20-25 packets per second to/from the game server, with each packet having about 40-60 bytes of data. To simulate real-time game play, packet latency must be sufficiently low to simulate real time movement within the game and to maintain consistent game state across all clients. For example, some games rely on packet latency of less than about 40 milliseconds (ms). High latency and/or packet loss can result in a poor user experience and can even make the game unplayable. As another example, Internet of Things (IoT) applications, such as Internet-connected sensors and beacons, may rely on relatively small packets being transmitted with low latency.

As is also known in the art, client-server computing systems may include a content delivery network (CDN) to efficiently distribute large files and other content to clients using edge nodes.

### SUMMARY

It is recognized herein that low-latency, low-bandwidth applications may be handled inefficiently by existing client-server computing systems. For example, existing systems may route each packet through the network, end-to-end, regardless of packet size. Various layers of the network stack may add a fixed-size header to its respective payload, and the combined size of these headers can be nearly as large as (or even bigger than) the application data being transported. For example, many low-latency, low-bandwidth applications use Ethernet for a link layer, Internet Protocol (IP) for a network layer, and User Datagram Protocol (UDP) for a transport layer. The combined headers added by these protocols may result in 55 bytes of application data being transmitted as about 107 bytes of network data and may require about 200 bytes of storage in network devices (e.g., due to internal data structures used by routers). Thus, less than half the actual packet size is allocated for the application data.

Moreover, low-latency, low-bandwidth applications may experience high levels of packet loss within existing client-server systems, particularly as the number of clients increases. Each packet may traverse a series of routers and other network devices that temporarily store the packets in fixed-size buffers. When a buffer is full, arriving packets will be dropped. Thus, a high rate of packets, even relatively small packets, can cause congestion within network routers leading to an increase in dropped packets.

One technique for addressing the aforementioned problems is to establish direct network paths (or “tunnels”) between clients (or ISPs via which clients access the network) and the server. While such tunnels can reduce (or even minimize) the number of network hops between clients and servers, they are typically expensive to setup and maintain.

Another technique to reduce packet congestion is to aggregate packets from a single client over time. This technique, sometimes referred to as “horizontal buffering” is generally unsuitable for low-latency applications such as multiple games.

Described herein are structures and techniques to improve the performance of low-latency, low-bandwidth client-server applications. The technique, referred to as “vertical packet aggregation,” leverages existing CDN infrastructure to reduce the number of packets that are sent through a network (e.g., the Internet), while increasing the space-wise efficiency of those packet that are sent. The structures and technique described herein can also be used to improve so-called “chatty” applications, such as web beacon data.

According to one aspect of the disclosure, a method is provided for vertical packet aggregation in a client-server system. The method comprises: receiving packets from a plurality of clients; generating an aggregate packet having a copy of the payload of two or more of the packets received from different ones of the plurality of clients within a common buffer period; and sending the generated aggregate packet to a remote server.

In some embodiments, receiving packets from a plurality of clients comprises receiving packets at a node within a distributed network. In certain embodiments, receiving packets from a plurality of clients comprises receiving packets at an edge node within a content delivery network (CDN). In particular embodiments, sending the generated aggregate packet to the remote server comprises sending the generated aggregate packet to a peer node within a distributed network. In various embodiments, sending the generated aggregate packet to the remote server comprises sending the generated aggregate packet to an ingest server within the CDN.

In some embodiments, generating the aggregate packet comprises generating an aggregate packet having metadata to associate each payload copy with one of the plurality of clients. In certain embodiments, generating the aggregate packet comprises generating an aggregate packet having a copy of payloads from client packets destined for one or more of the same remote servers. In particular embodiments, generating the aggregate packet comprises generating an aggregate packet having a copy of at most one payload from each of the plurality of clients. In various embodiments, receiving packets from a plurality of clients comprises receiving packets comprising multiplayer game data. In some embodiments, receiving packets from a plurality of clients comprises receiving packets Internet of Things (IoT) data.

In certain embodiments, the method further comprises processing one or more of the received packets. In some embodiments, processing the one or more received packets includes compressing data within the one or more received packets. In various embodiments, processing the one or more received packets includes encrypting data within the one or more received packets. In particular embodiments, processing the one or more received packets includes augmenting data within the one or more received packets. In some embodiments, processing the one or more received packets includes filtering the one or more of the received packets. In certain embodiments, receiving packets from a plurality of clients includes receiving packets using at least two different protocols.

In various embodiments, the method further comprises selecting the two or more packets based on the order packets were received from the clients. In some embodiments, the method further comprises selecting the two or more packets based on priority levels associated with ones of the plurality of clients. In particular embodiments, the method further comprises: storing the packets received from a plurality of clients; and regenerating and resending the aggregate packet using the stored packets. In some embodiments, receiving packets from a plurality of clients includes receiving a multicast packet from a client. In various embodiments, sending the generated aggregate packet to a remote server includes sending a multicast packet having a multicast group id associated with the remote server.

According to another aspect of the disclosure, a system comprises a processor; a volatile memory; and a non-volatile memory storing computer program code that when executed on the processor causes the processor to execute a process operable to perform one or more embodiments of the method described above.

### BRIEF DESCRIPTION OF THE DRAWINGS

The foregoing features may be more fully understood from the following description of the drawings in which:

FIG. 1 is a block diagram of a client-server computing system, according to an embodiment of the disclosure;

FIG. 1A is a block diagram illustrating routing in a client-server computing system, according to some embodiments;

FIG. 2 is timing diagram illustrating vertical packet aggregation, according to some embodiments of the disclosure;

FIG. 3 is diagram illustrating the format of a vertically aggregated packet, according to some embodiments of the disclosure;

FIG. 4 is a block diagram of a client-server computing system, according to another embodiment of the disclosure;

FIG. 4A is a block diagram of a client-server computing system, according to yet another embodiment of the disclosure;

FIGS. 5 and 6 are flow diagrams illustrating processing that may occur within a client-server computing system, in accordance with some embodiments; and

FIG. 7 is block diagram of a computer on which the processing of FIGS. 5 and 6 may be implemented, according to an embodiment of the disclosure.

The drawings are not necessarily to scale, or inclusive of all elements of a system, emphasis instead generally being placed upon illustrating the concepts, structures, and techniques sought to be protected herein.

### DETAILED DESCRIPTION

To aid in understanding, embodiments of the disclosure may be described herein using specific network protocols, such as Internet Protocol (IP), User Datagram Protocol (UDP), and/or Transmission Control Protocol (TCP). Those skilled in the art will appreciate that the concepts, techniques, and structures sought to be protected herein can also be applied to networking applications that use other networking protocols. For example, the techniques described herein may be applied to IoT applications using a narrow-band network of drones.

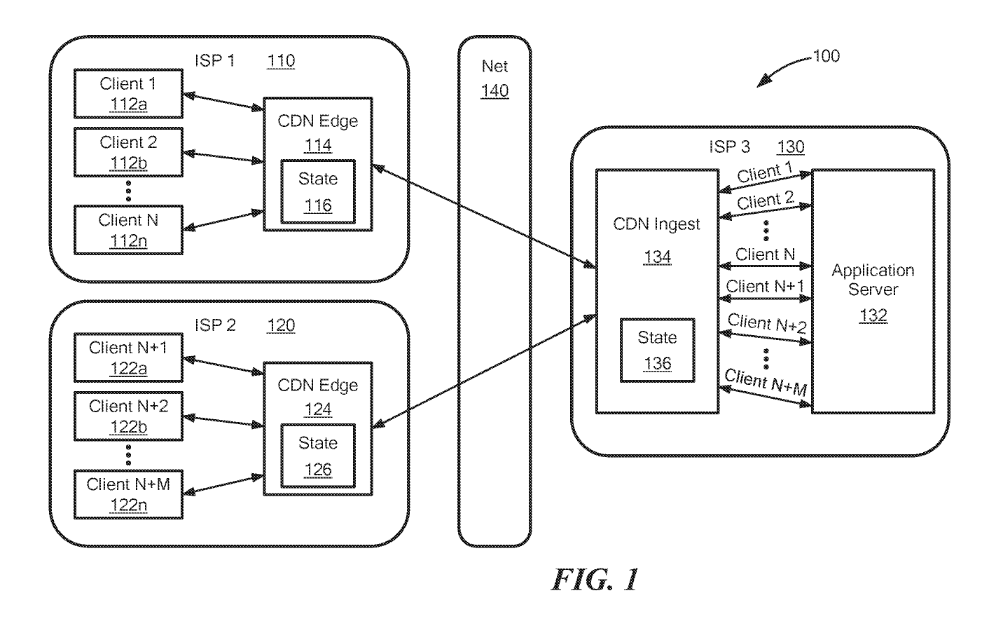

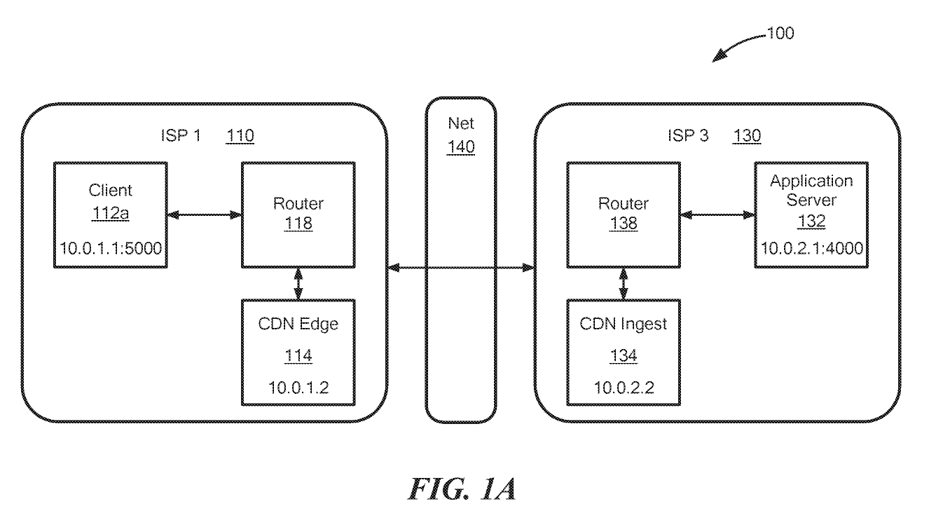

FIG. 1 shows a client-server computing system 100 using vertical packet aggregation, according to an embodiment of the disclosure. The illustrative system 100 includes an application server 132 and a plurality of clients 112a-112n, 122a-122n configured to send/receive packets to/from the application server 132 via a wide-area network (WAN) 140. In many embodiments, the WAN 140 is a packet-switched network, such as the Internet.

A given client may access the WAN 140 via an Internet Service Provider (ISP). For example, the client may be a customer of the ISP and use the ISP' s cellular network, cable network, or other telecommunications infrastructure to access the WAN 140. In the embodiment of FIG. 1, a first plurality of clients 112a-112n (112 generally) may access the network 140 via a first ISP 110, and a second plurality of clients 122a-122n (122 generally) may access the network 140 via a second ISP 120.

The application server 132 may likewise access the network 140 via an ISP, specifically a third ISP 130 in the embodiment of FIG. 1. It should be appreciated that the application server 132 may be owned/operated by an entity that has direct access to the WAN 140 (i.e., without relying on access from a third-party) and, thus, the third ISP 130 may correspond to infrastructure owned/operated by that entity.

The computing system 100 can host a wide array of client-server applications, including more low-latency, low-bandwidth applications. In one example, clients 112, 122 may correspond to players in a multiplayer online game and application server 132 may correspond to a central game server that coordinates game play among the players. In another example, the clients 112, 122 may correspond to Internet of Things (IoT) devices and the application server 132 may provide services for the IoT devices. For example, clients 112, 122 may correspond to “smart” solar/battery systems connected to the electrical grid that report energy usage information to a central server operated by an energy company (i.e., server 132).

The client-server computing system 100 also includes a content delivery network (CDN) comprising a first edge node 114, a second edge node 124, and an ingest is node 134. In the example shown, the application server 132 may correspond to an origin server of the CDN. The first and second CDN edge nodes 114, 124 may be located within the first and second ISPs 110, 120, respectively. Thus, the first plurality of clients 112 may be located closer (in terms of geographic distance or network distance) to the first edge node 114 compared to the application server 132. Likewise, the second plurality of clients 122 may be located closer to the second edge node 124 compared to the application server 132.

Conventionally, CDNs have been used to improve the delivery of static content (e.g., images, pre-recorded video, and other static content) and dynamic content served by an origin server by caching or optimizing such content at CDN edge nodes located relatively close to the end users / clients. Instead of requesting content directly from the origin server, a client sends its requests to a nearby edge node, which either returns cached content or forwards (or “proxies”) the request to the original server. It will be understood that existing CDNs may also include an ingest node located between the edge nodes and the origin server. Conventionally, the ingest node is configured to function as second layer of caching in the CDN edge network, thereby reducing load on the origin server and reducing the likelihood of overloading the origin server in the case where many edge node cache “misses” in a relatively short period of time.

It should be understood the nodes 114, 124, 134 form a type of distributed network, wherein the nodes cooperate with each other (i.e., act as a whole) to provide various benefits to the system 100. In some embodiments, each of the nodes 114, 124, 134 may be peer nodes, meaning they each include essentially the same processing capabilities. Although the distributed network may be referred to herein as a CDN, it should be understood that, in some embodiments, the nodes 114, 124, 134 may not necessarily be used to optimize content delivery (i.e., for conventional CDN purposes).

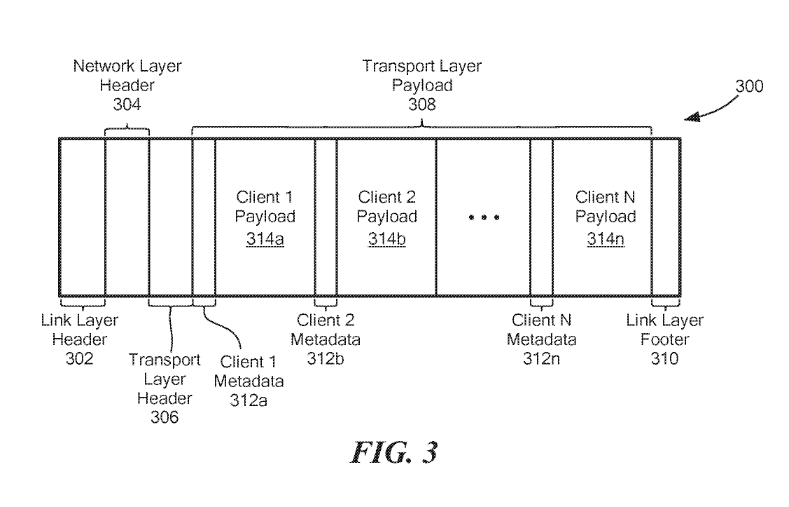

In various embodiments, the CDN edge nodes 114, 124 and ingest node 134 are configured to improve the performance of low-latency, low-bandwidth applications using vertical packet aggregation. In particular, when clients 112, 122 generate and send packets destined for applications server 132, the client packets may be received by a CDN edge node 114, 124. The CDN edge nodes 114, 124 are configured to store the received client packets (e.g., in a queue) and, in response to some triggering condition, to generate an aggregate packet based upon one or more of the stored client packets. The aggregate packet includes a copy of client packet payloads, along with metadata used to process the aggregate packet at the CDN ingest node 134. In certain embodiments, all client packets within the aggregate packet are destined for the same origin server (e.g., application server 132). An illustrative aggregate packet format is shown in FIG. 3 and described below in conjunction therewith.

The CDN nodes 114, 124, 135 may use one or more triggering conditions (or “triggers”) to determine when an aggregate packet should be generated. In some embodiments, aggregates packets within a given window of time referred to herein as a “buffer period.” Using a clock, a node can determine when each buffer period begins and ends. At the end of a buffer period, some or all of the stored packets may be aggregated. In certain embodiments, an aggregate packet may be generated if the number of stored packets exceeds a threshold value and/or if the total size of the stored packets exceeds a threshold value.

In some embodiments, the CDN nodes 114, 124, 135 aggregate packets in the order they were received e.g., using a queue or other first-in, first-out (FIFO) data structure.

In other embodiments, CDN nodes 114, 124, 135 may aggregate packets out-of-order, such that a given client packet may be aggregated before a different client packet received earlier-in-time. For example, each client 112 may be assigned a priority level, and the CDN nodes 114, 124, 135 may determine which stored packets to aggregate based on the client priority levels.

In certain embodiments, an edge node 114, 124 that receives a client packet may determine if that packet should or should not be aggregated. In some embodiments, an edge node 114, 124 receives client packets on the same port number (e.g., the same UDP or TCP port number) as the origin server, and thus the edge node 114, 124 may aggregate only packets received on selected port numbers (e.g., only ports associated with low-latency, low-bandwidth applications that may benefit from vertical aggregation). In certain embodiments, an edge node 114, 124 may inspect the client packet payload for a checksum, special signature, or other information that identifies the packet as being associated with a low-latency, low-bandwidth application. In particular embodiments, an edge node 114, 124 may check the client packet source and/or destination address (e.g., source/destination IP address) to determine if the packet should be aggregated. In certain embodiments, an edge node 114, 124 may aggregate at most one packet per client source address per buffer period.

The edge node 114, 124 sends the aggregate packet to the CDN ingest node 134, which generates a plurality of packets based on the received aggregate packet. Each of the generated packets may include a copy of the payload for one of the client packets on which the aggregate packet was based. In some embodiments, the source IP address of the generated packets is set to that of the original clients addresses as identified by metadata within the aggregate packet. The CDN ingest node 134 sends each of generated packets to the application server 132 for normal processing.

It will be appreciated that the CDN edge node 114, 124 are configured to multiplex a plurality of client packets into an aggregate packet, and the CDN ingest node 134 de-multiplexes the aggregate packet to “recover” the client packets for processing by the application server.

In some embodiments, clients 112, 122 may be configured to send packets, destined for the application server 312, to the CDN edge nodes 114, 124 (i.e., the clients may explicitly proxy packets through the CDN edge nodes). In other embodiments, clients 112, 122 may be configured to send packets to the application server 132 and the packets may be re-routed to an edge node 114, 124 in a manner that is transparent to the clients. For example, an ISP 110, 120 may have routing rules to re-route packets destined for the application server 132 to a CDN edge node 124. Thus, it will be appreciated that, in some embodiments, an ISP can take advantage of the vertical packet aggregation techniques disclosed herein without requiring clients to be reconfigured.

In many embodiments, vertical packet aggregation may also be used in the reverse direction: i.e., to aggregate packets sent from the application server 132 to a plurality of clients 112, 122. In particular, the CDN ingest node 134 may receive a plurality of packets from the application server 132 that are destined for multiple different clients. The CDN ingest node 134 may determine which received packets are destined for clients within the same ISP, and aggregate such packets received with the same buffer is period, similar to the aggregation performed by CDN edge nodes as described above.

The ingest node may send the aggregate packet to a CDN edge node, which de-multiplexes the aggregate packet to generate a plurality of client packets which are the sent to the clients within the same ISP.

In various embodiments, the CDN edge nodes and/or CDN ingest node may maintain state information used for vertical packet aggregation. For example, as shown, edge node 114 may maintain state 116, edge node 124 may maintain state 126, and ingest node 134 may maintain state 136. In some embodiments, an aggregate packet includes a client IP address for each corresponding client packet therein, and the ingest node state 136 includes a mapping the port number and IP address used to connect to the application server 132 for which client. In other embodiments, an aggregate packet may include a synthetic identifier for each client (e.g., a value that consumes less space than an IP address). In such embodiments, both the edge node state 116, 126 and the ingest node state 136 may include a mapping between synthetic client identifiers and client IP address and, in some cases, port number.

It will be appreciated that aggregating packets across clients can reduce overhead within the network 140. Moreover, so long as the buffer period is kept sufficiently small, the effect of vertical packet aggregation technique on packet latency may be negligible. For example, for multiple games, the buffer period duration may be 1-2 ms. As another example, for IoT applications, the buffer period may be 5-10 ms.

It will be further appreciated that the CDN nodes 114, 124, 134 can provide vertical packet aggregation without having knowledge of the application-layer protocol between the clients 112, 122 and application server 132. Alternatively, the CDN nodes 114, 124, 134 could be configured to have partial or full knowledge of an application protocol in order to provide additional benefits. In particular embodiments, a CDN edge node 114, 124 can use knowledge of the application protocol in order to filter packets that could be harmful or unnecessary to send to the application server 132. For example, the CDN edge nodes 114, 124 could use knowledge of an application protocol to rate-limit packets from individual clients 112, 122, thereby preventing denial-of-service (DoS) attacks, cheating, or other illegitimate client behavior.

In various embodiments, one or more of the nodes within system 100 may utilize multicasting to reduce network traffic. In some embodiments, ingest node 134 may aggregate multiple packets received from the application server 132 into a single multicast packet, which is sent through the network 140 to multiple receivers in the same multicast group. For example, referring to the example of FIG. 1, assume application server 132 sends a first packet destined for first edge node 114 and a second packet destined for second edge node 124, where the first and second packets include the same payload (e.g., the same game status information). The two packets may be intercepted/received by the ingest node 134, which determines that the first 114 and second 124 edge nodes are associated with the same multicast group. Instead of sending separate packets to each edge node 114, 124, the ingest node 134 may send a single multicast packet having the common payload to the multicast group. In certain embodiments, the application server 132 may send a multicast packet destined for multiple clients (e.g., clients 112a-112n), which may be intercepted and aggregated by the ingest node 134.

FIG. 1A shows another view of a client-server computing system 100, in which like elements of FIG. 1 are shown using like reference designators. As discussed above in conjunction with FIG. 1, in some embodiments, a client 112a may be configured to explicitly proxy server-bound packets through a CDN edge node 114, thereby providing an opportunity for the edge node 114 to perform vertical packet aggregation. As also described above, in other embodiments, the client 112a may be configured to send packets directly to an application server 132 and the packets may be transparently routed (e.g., using special routing rules in router 118) through the edge node 114 to allow for vertical packet aggregation. Similarly, in the reverse direction, the application server 132 may be configured to explicitly proxy client-bound packets through a CDN ingest node 134 or such packets may be transparently routed (e.g., using special routing rules in router 138) through the ingest node 134.

These different routing scenarios described above may be better understood by the following simplified examples wherein it is assumed that client 112a, edge node 114, ingest node 134, and application server 132 are assigned network addresses 10.0.1.1, 10.0.1.2, 10.0.2.2, and 10.0.2.1, respectively as shown in FIG. 1A. It is further assumed that client 112a is running a client application on port 5000 and that application server 132 is running a server application on port 4000. As used in the following examples, the format X.X.X.X:YYYY denotes network address X.X.X.X and port YYYY.

TABLE 1

| Step | Sender | Source Address | Destination Address |
|---|---|---|---|
| 1 | Client | 10.0.1.1:5000 | 10.0.1.2:4000 |
| 2 | Edge Node | 10.0.1.2 | 10.0.2.2 |
| 3 | Ingest Node | 10.0.2.2:6000 | 10.0.2.1:4000 |
| 4 | Application Server | 10.0.2.1:4000 | 10.0.2.2:6000 |
| 5 | Ingest Node | 10.0.2.2 | 10.0.1.2 |
| 6 | Edge Node | 10.0.1.2:4000 | 10.0.1.1:5000 |

TABLE 1 illustrates the case where both the client 112a and the application server 132 are configured to explicitly proxy through respective CDN nodes 114 and 134. At step 1, client 112a sends a packet having source address 10.0.1.1:5000 and destination address 10.0.1.2:4000 (i.e., the client explicitly proxies through the edge node 114). At step 2, the edge node 114 generates and sends a vertically aggregated packet based on the client packet, the vertically aggregated packet having source address 10.0.1.2 and destination address 10.0.2.2. At step 3, the ingest node 134 parses the vertically aggregated packet and sends a copy of the original client packet with source address 10.0.2.2:6000 and destination address 10.0.2.1:4000 (port 6000 may be an arbitrary port used by the ingest node 134 for this particular client packet). The ingest node 134 may add a mapping between its port 6000 and client address 10.0.1.1:500 to its local state (e.g., state 136 in FIG. 1).

In the reverse direction, at step 4, the application server 132 sends a packet having source address 10.0.2.1:4000 and destination address 10.0.2.2:6000 (i.e., the application server explicitly proxies through the ingest node 134). At step 5, the ingest node 134 determines that port 6000 is mapped to client address 10.0.1.1:500 and, based on this information, sends a packet (e.g., a vertically aggregated packet) having source address 10.0.2.2 and destination address 10.0.1.2. At step 6, edge node 114 may process the received packet (e.g., parse a vertically aggregated packet) and send a packet having source address 10.0.1.2:4000 and destination address 10.0.1.1:5000.

TABLE 2

| Step | Sender | Source Address | Destination Address |
|---|---|---|---|
| 1 | Client | 10.0.1.1:5000 | 10.0.2.1:4000 |
| 2 | Edge Node | 10.0.1.2 | 10.0.2.2 |
| 3 | Ingest Node | 10.0.1.1:5000 | 10.0.2.1:4000 |
| 4 | Application Server | 10.0.2.1:4000 | 10.0.1.1:5000 |
| 5 | Ingest Node | 10.0.2.2 | 10.0.1.2 |
| 6 | Edge Node | 10.0.2.1:4000 | 10.0.1.1:5000 |

TABLE 2 illustrates the case where the client 112a and the application server 132 are configured to send packets directly to each other, and where such packets are transparently routed through CDN nodes 114, 134. At step 1, client 112a sends a packet having source address 10.0.1.1:500 and destination address 10.0.2.1:4000 (i.e., directly to the application server). Router 118 is configured to route the packet to CDN edge node 114, which in turn (step 2) generates and sends a vertically aggregated packet based on the client packet, the vertically aggregated packet having source address 10.0.1.2 and destination address 10.0.2.2. At step 3, the CDN ingest node 134 generates a copy of the client packet based on the vertically aggregated packet, and sends the client packet having source address 10.0.1.1:5000 and destination address 10.0.2.1:4000. Thus, the ingest node 134 “spoofs” the packet source address such that it appears the application server 132 as if the packet was sent directly from client 112a.

In the reverse direction, at step 4, the application server 132 sends a packet having source address 10.0.2.1:4000 and destination address 10.0.1.1:5000 (i.e., directly to the client 112a). Router 138 is configured to route the packet to ingest node 134. At step 5, the ingest node 134 sends a packet (e.g., a vertically aggregated packet) having source address 10.0.2.2 and destination address 10.0.1.2. At step 6, the edge node 114 may process the received packet (e.g., parse a vertically aggregated packet) and send a packet having source address 10.0.2.1:4000 and destination address 10.0.1.1:5000. Thus, the edge node 114 “spoofs” the packet source address such that it appears to the client 112a as if the packet was sent directly from the application server 132.

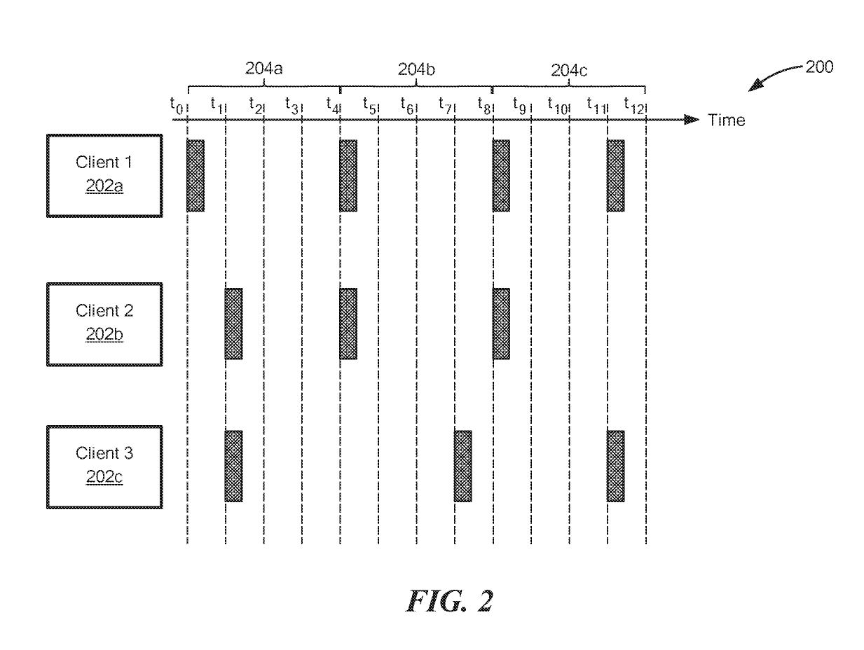

Referring to FIG. 2, vertical packet aggregation is illustrated using a timing diagram 200. A plurality of clients 202a-202c (generally denoted 202 and shown along a vertical axis of diagram 200) each send a stream of packets shown as hatched rectangles in the figure. Each packet has a corresponding time (e.g., t₀, t₁, t₂, etc.) shown along a horizontal axis of diagram 200. In many embodiments, all clients 202 are within the same ISP (e.g., ISP 110 in FIG. 1) or otherwise located close to a common CDN edge node (e.g., node 114 in FIG. 1). In certain embodiments, the packet times correspond to times the packets were received at the CDN edge node. In the example shown, a CDN edge node may receive packets from a first client 202a having times t₀, t₄, t₈, and t₁₁; packets from a second client 202b having times t₁, t₄, and t₈; and packets from a third client 202c having times t₁, t₇, and t₁₁.

A CDN edge node may be configured to aggregate packets received from multiple different clients 202 within the same window of time, referred as a “buffer period” and generally denoted 204 herein. The duration of a buffer period 204 may be selected based upon the needs of a given application and/or client-server computing system. In general, increasing the buffer period duration may increase the opportunity for vertical aggregation and, thus, for reducing congestion within the network. Conversely, decreasing the buffer period duration may decrease client-server packet latency. In some embodiments, the buffer period duration may be selected based in part on the maximum acceptable latency for a given application. In certain embodiments, the duration of a buffer period 204 may be selected in an adaptive manner, e.g., based on observed network performance. In one embodiment, a buffer period 204 duration may to be 1-2 ms. In another embodiment, a buffer period 204 duration may be 5-10 ms. For some applications, a much longer buffer period may be used. For example, packets may be stored and aggregated over several hours, days, weeks, or years for certain narrowband applications.

Many networks or network devices (e.g., routers, switches, etc.) may have a so-called maximum transfer unit (MTU) value that determines the maximum packet size that can be handled. A typical MTU value may be about 1500 bytes. Accordingly, in certain embodiments, a CDN edge node may limit the amount of client payload data that is aggregated based not only on the buffer period duration, but also on an MTU value. For example, a CDN edge node may generate an aggregate packet before a buffer period if aggregating additional data would exceed an MTU value.

In the simplified example of FIG. 2, the CDN edge node is configured to use a fixed-duration buffer period of four (4) time units. In particular, a first buffer period 204a covers times [t₀, t₄), a second buffer period 204b covers times [t₄, t₈), a third buffer period 204c covers times [t₈, t₁₂), and so on.

Within a given buffer period 204, the CDN edge node may receive packets from one or more clients 202, each client packet being destined for a specific origin server (e.g., application server 132 of FIG. 1). As the client packets are received, the edge node may collect packets. In some embodiments, the CDN edge node buffers packets in memory. In many embodiments, the CDN edge node buffers together packets that are destined for a common origin server. In certain embodiments, the CDN edge may buffer packets that are destined for certain origin servers, but not others (i.e., vertical packet aggregation may be configured on a per-origin server basis).

At the end of a buffer period 204, the CDN edge node many generate an aggregate packet that includes a copy of the payloads from one or more buffered client packets, along with metadata to identify the client associated with each payload. In various embodiments, the client packets and the aggregate packet comprise UDP packets. In some embodiments, the client packets and the aggregate packet comprise TCP packets.

Referring to the example of FIG. 2, during a first buffer period 204a, a CDN edge node may collect a packet received from client 202a having time t₀, a packet received from to client 202b having time t₁, and a packet received from client 202c also having time t₁. At the end of the first buffer period 204a (e.g., at or around time t₄), the CDN edge node may generate an aggregate packet comprising a copy of the payloads for the aforementioned packets along with metadata to identify the corresponding clients 202a-202c. In various embodiments, the aggregate packet may have the format that is the same as or similar to the packet format described below in conjunction with FIG. 3.

In some embodiments, the CDN edge node is configured to send the aggregate packet to a CDN ingest node (e.g., ingest node 134 in FIG. 1). In other embodiments, the CDN edge node is configured to send the aggregate packet directly to an origin server (e.g., application server 132 in FIG. 1). In either case, the receiver may be configured to de-multiplex the aggregate packet and send the client payloads to the origin server for normal processing.

In particular embodiments, to prevent excessive latency between a particular client and the origin server, the edge node buffers at most one packet per client within a given buffer period. Thus, using FIG. 2 as an example, an aggregate packet generated for buffer period 204c may include either packet t₈ or packet t₁₁ received from client 202a, but not both packets.

FIG. 3 illustrates a packet format 300 that may be used for vertical packet aggregation, according to some embodiments of the disclosure. The packet format 300 includes a link layer header 302, a network layer header 304, a transport layer header 306, a transport payload 308, and a link layer footer 310.

In some embodiments, the link layer header 302 comprises an Ethernet header including a preamble, a start of frame delimiter, a media access control (MAC) destination address, and a MAC source address. In particular embodiments, the link layer header 302 has a size of twenty-two (22) to twenty-six (26) bytes.

In some embodiments, the network layer header 304 comprises an Internet Protocol (IP) header including a source IP address, and a destination IP address, and other IP header information. In particular embodiments, the network layer header 304 has a size of twenty (20) to thirty-two (32) bytes. In some embodiments, the IP source address may be set to an address of the CDN edge node where the aggregate packet is generated. In certain embodiments, the IP destination address may be set to an IP address of a CDN ingest node (e.g., node 134 in FIG. 1). In other embodiments, the IP destination address may be set to an IP address of an application server (e.g., is application server 132 in FIG. 1).

In some embodiments, the transport layer header 306 comprises a UDP header including a source port, a destination port, a length, and a checksum. In particular embodiments, the transport layer header 306 is eight (8) bytes in size. In some embodiments, the destination port may be set to a port number associated with the application server (e.g., application server 132 in FIG. 1).

In certain embodiments, the link layer footer 310 is an Ethernet frame check sequence comprising a cyclic redundancy code (CRC). In particular embodiments, the link layer footer 310 is about four (4) bytes in size (e.g., a 32-bit CRC).

The transport layer payload 308 is a variable-sized segment comprising one or more client packet payloads 314a, 314b, . . . , 314n (314 generally). Each client packet payload 314 may correspond to a payload sent by a client (e.g., a client 112 in FIG. 1) and received by a CDN edge node (e.g., edge node 114 in FIG. 1) within the same buffer period. The transport layer payload 308 may also include metadata 312a, 312b, . . . , 312n (312 generally) for each respective client packet payload 314a, 314b, 314n, as shown. The metadata 312 may include information to identify the client associated with each of the payloads 314. In some embodiments, metadata 312 may include an IP address for each of the clients. In other embodiments, metadata 312 may include a synthetic identifier for each of the clients (e.g., a value that consumes less space than an IP address). In various embodiments, an aggregate packet 300 includes about eight (8) bytes of metadata 312 for each client payload 314.

In some embodiments, the transport layer payload 308 may include a header segment (not shown in FIG. 3) used to distinguish the vertically aggregated packet 300 from a conventional packet (i.e., a packet having data for a single client). For example, the header segment could include a “magic number” or checksum to distinguish it from a conventional packet. In particular embodiments, a timestamp may be included within the transport layer payload 308, and the entire payload 308 may be encrypted (including timestamp) using symmetric encryption with a key known only by edge and ingest. This may be done to prevent packet replay.

It will be appreciated that the aggregating a plurality of client packet payloads 314 within a single packet as illustrated in FIG. 3 can be significantly more efficient—in terms of bandwidth and other network resource consumption—compared to sending separate packets for each client through the network. For example, using the illustrative aggregate packet format 300, the total overhead due to the headers 302, 304, 306 and the footer 310 may be about fifty-four (54) bytes, and this overhead can be amortized over many client payloads. Moreover, the benefits tend to increase as the size of the client payloads decrease and the rate of packet transmission increases.

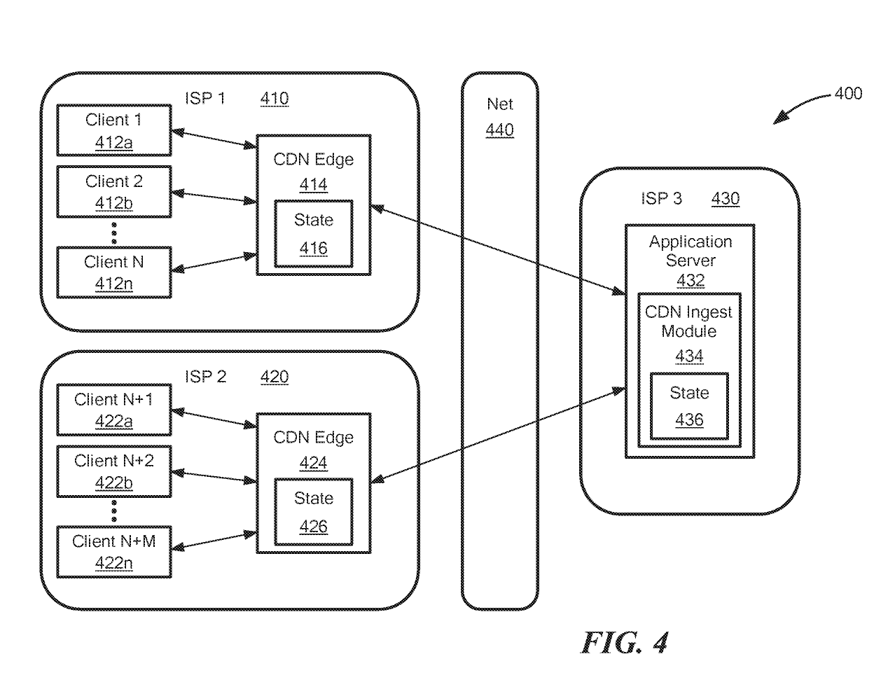

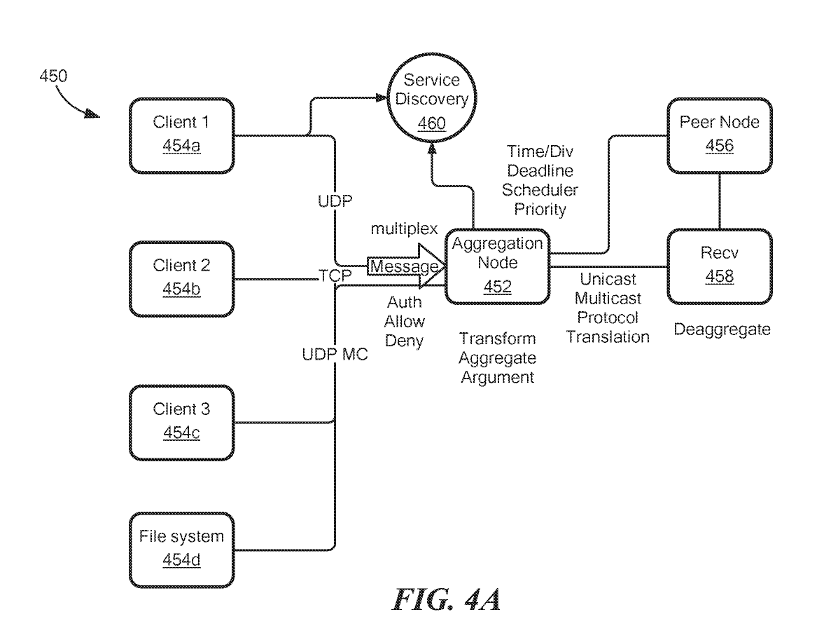

FIG. 4 shows another embodiment of a client-server computing system 400 using vertical packet aggregation. The illustrative system 400 includes a first ISP 410 and a second ISP 420, each of which is connected to a third ISP 430 via a wide-area network (WAN) 440. The first and second ISPs 410, 420 include respective CDN edge nodes 414, 424, and the third ISP 420 includes an application server 432 having a CDN ingest module 434. The first ISP 410 provides access to the network 440 for a first plurality of clients 412a-412n, and the second ISP 420 provides access for a second plurality of clients 422a-422n.

The clients 412a-412n, 422a-422n are configured to send/receive packets to/from the application server 432 via the network 440. In the example shown, packets sent by clients 412a-412n may be received by CDN edge node 414 and packets sent by clients 422a-422n may be received by CDN edge node 424. In some embodiments, the clients 412, 422 are configured to send the packets, destined for the application server 432, to the CDN edge nodes 414, 424. In other embodiments, the client packets may be rerouted to the CDN edge nodes using special routing rules within the ISPs 410, 420. The CDN edge nodes 414, 424 may aggregate packets received from two or more different clients, within a given buffer period, that are destined for the same origin server (e.g., application server 432).

In contrast to the system 100 of FIG. 1, the system 400 in FIG. 4 does not include a dedicated CDN ingest node. Instead, the CDN edge nodes 416, 424 may be configured to send aggregate packets directly to the application server 432, which is configured to internally de-multiplex and process the aggregate packets. In the embodiment shown, such processing may be implemented within the CDN ingest module 434.

In various embodiments, the CDN edge nodes 416, 424 and/or the CDN ingest module 434 may maintain state information used for vertical packet aggregation. For example, as shown, edge node 414 may maintain state 416, edge node 424 may maintain state 426, and ingest module 434 may maintain state 436.

It is appreciated herein that certain benefits can be had by performing vertical packet aggregation and/or de-multiplexing directly within an application server (e.g., application server 432). For example, the overhead required to open connections between the CDN ingest node and the application server can be avoided. As another example, the application server 432 can use multicasting techniques to send data to many clients 412, 422 using a single packet. For multiple games, instead of sending game status to each client individually, the application server can send a status packet to a client multicast group. For example, if the application server 432 wants to send a packet to both clients 412 a and 412 b, it could send more than a single packet—comprising metadata to identify both clients and a single payload—to the edge node 414 rather than two separate payloads. In certain embodiments, the application server 432 may inform an edge node 414, 424 that certain clients belong to a given multicast group. That makes it possible to send a packet to many clients while transmitting a single packet comprising a single copy of the payload a multicast group identifier. In some embodiments, an edge node may itself use multicasting to send a single aggregate packet to multiple ingest nodes or multiple application servers.

FIG. 4A shows another embodiment of a client-server computing system 450 that can utilize vertical packet aggregation. An aggregation node 452 receives and stores packets from one or more sources 454a-454d (454 generally), performs vertical aggregation on received packets, and sends corresponding aggregate packets to either a receiver (e.g., an application server) 458 or a peer node 456. The aggregation node 452 may also perform other packet processing, such as filtering, data augmentation, and/or data transformation. The aggregation and peer nodes 452, 456 may form a part of a distributed network. For example, the aggregation node 452 and peer node 456 may correspond to a CDN edge node and a CDN ingest node, respectively.

In certain embodiments, the aggregation node 452 may augment packets with one or more of the following: subscriber information; demographic information; network capacity/limit information; a quality of service (QoS) level; geo-location information; user device information; network congestion information; and/or network type information.

In certain embodiments, the aggregation node 452 may resend aggregate packets to the receiver 458 and/or peer node 456 based on retransmission criteria defined for an application. To allow for retransmission, the aggregation node 452 can retain stored client packets after a corresponding aggregate packet is sent. Packets may be retained (i.e., persisted) for several hours, days, weeks, years, etc. In a particular embodiment, packets are stored for more than one (1) hour. The duration for which packets are retained may be selected based on the needs of a given application.

Sources 454 may include one or more of clients 454a-454c each configured to send packets using one or more protocols. In the example shown, a first client 454a sends UDP (unicast) packets, a second client 454b sends TCP packets, a third client 454c sends UDP multicast packets. Sources 454d may also include filesystems (e.g., filesystem 454d), in which case “packets” sent thereby may correspond to files or portions thereof. The aggregation node 452 can receive packets in multiple different data formats (e.g., protocols) and generate vertically aggregated packets using an internal data format. The internal data format may be more efficient in terms of processing and bandwidth consumption relative to the input formats.

In the embodiment to FIG. 4A, the aggregation node 452 may receive information from a service discovery module 460 that determines the types of packet processing performed by node 452 (e.g., filtering, transformation, and/or vertical aggregation), along with parameters for each type of processing. In one example, the service discovery module 460 provides trigger condition information used for vertical packet aggregation, such as the buffer period duration or total stored data threshold. In some embodiments, the service discovery 460 can provide the aforementioned information on a per-application or per-service basis. In certain embodiments, the service discovery module 460 or aggregation node 452 may use a scheduler to determine when aggregate packets should be generated. In certain embodiments, the service discovery module 460 may assign a priority level to each source 454 and the aggregation node 452 may use this information to determine when particular client packets should be aggregated and sent to the peer node 456 and/or receiver 458.

The aggregation node 452 may send aggregate packets to one or more receivers 458 using unicast or multicast (e.g., UDP multicast or TCP multicast). In addition, the aggregation node 452 may receive a multicast packet sent by one of the sources 454 and include a copy of the multicast packet payload and group id within a generated aggregate packet. The peer node 456 can receive the aggregate packet and delivery the multicast packet payload to multiple receivers 458 using either unicast or multicast. Thus, the system 450 can use multicast in at least two different ways to optimize network traffic.

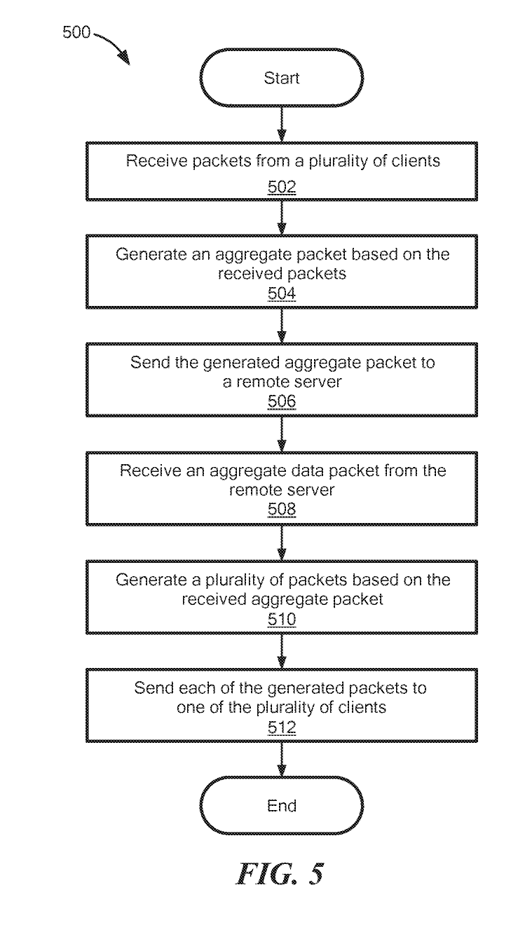

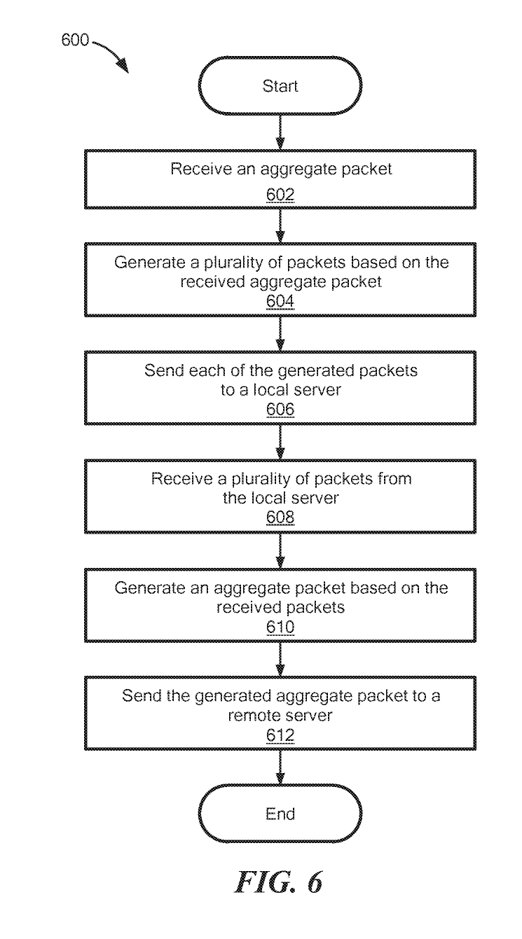

FIGS. 5 and 6 are flow diagrams showing illustrative processing that can be implemented within a client-server computing system (e.g., system 100 of FIG. 1 and/or system 400 of FIG. 4). Rectangular elements (typified by element 502 in FIG. 5), herein denoted “processing blocks,” represent computer software instructions or groups of instructions. Alternatively, the processing blocks may represent steps performed by functionally equivalent circuits such as a digital signal processor (DSP) circuit or an application specific integrated circuit (ASIC). The flow diagrams do not depict the syntax of any particular programming language but rather illustrate the functional information one of ordinary skill in the art requires to fabricate circuits or to generate computer software to perform the processing required of the particular apparatus. It should be noted that many routine program elements, such as initialization of loops and variables and the use of temporary variables may be omitted for clarity. The particular sequence of blocks described is illustrative only and can be varied without departing from the spirit of the concepts, structures, and techniques sought to be protected herein. Thus, unless otherwise stated, the blocks described below are unordered meaning that, when possible, the functions represented by the blocks can be performed in any convenient or desirable order. In some embodiments, the processing blocks represent states and transitions, respectively, within a finite-state machine, which can be implemented in software and/or hardware.

FIG. 5 shows a method 500 for vertical packet aggregation and de-multiplexing, according to some embodiments of the disclosure. In certain embodiments, at least a portion of the processing described herein below may be implemented within a CDN edge node (e.g., edge node 114 in FIG. 1).

At block 502, packets are received from a plurality of clients and, at block 504, an aggregate packet is generated based on the received packets. The generated aggregate packet includes a copy of the payloads of two or more of the received packets. In some embodiments, the generated aggregate packet includes a copy of the payload of packets received within the same buffer period. In various embodiments, the generated aggregate packet includes a copy of the payload of packets destined for the same application server (e.g., the packets may have the same destination IP address). In many embodiments, the aggregate packet includes metadata to identify the clients corresponding to each of the packet payloads included within the aggregate packet. In certain embodiments, the aggregate packet includes at most one payload per client.

At block 506, the aggregate packet is sent to a remote server. In some embodiments, the aggregate packet is sent to a remote CDN ingest node. In other embodiments, the aggregate packet in sent to an application server.

In certain embodiments, the aggregate packet may include packet data for two or more different applications. For example, a packet received from a game client may be aggregated together with a packet received from a different game's client, or with a non-gaming packet (e.g., a packet received from an IoT client). In this case, the remote server (e.g., a remote CDN ingest node) may handle de-multiplexing the aggregated packets and delivering them to the appropriate application servers.

At block 508, an aggregate packet is received from the remote server (e.g., the CDN ingest node or the application server). At block 510, a plurality of packets are generated based on the received aggregate packet. At block 512, each of the generated packets is sent to a corresponding one of the plurality of clients. In many embodiments, the received aggregate packet includes a plurality of client packet payloads and metadata used to determine which payloads should be sent to which clients.

FIG. 6 shows a method 600 for de-multiplexing and vertical packet aggregation, according some embodiments. In certain embodiments, at least a portion of the processing described herein below may be implemented within a CDN ingest node (e.g., ingest node 134 in FIG. 1). In other embodiments, the at least a portion of the processing may be implemented within an application server (e.g., application server 432 in FIG. 4).

At block 602, an aggregate packet is received and, at block 604, a plurality of packets is generated based on the received aggregate packet. In some embodiments, the aggregate packet is received from a CDN edge node. In various embodiments, the received aggregate packet includes a copy of packet payloads sent by two or more different clients. In certain embodiments, each generated packet includes a copy of a corresponding packet payload. In certain embodiments, the aggregate packet may include packet data for two or more different applications (e.g., two or more different gaming applications).

At block 606, each of the generated packets is sent to a local server. In some embodiments, the packets are sent from a CDN ingest node to an application server. In other embodiments, wherein the packets are generated within the application server itself, the processing of block 606 may be omitted.

At block 608, a plurality of packets is received from the local server. Each of the received packets may be associated with a particular client. At block 610, an aggregate packet is generated based on the received packets. The generated packet includes a copy of the payloads form the received packets. In some embodiments, the generated packet may further include metadata to identify which payloads correspond to which clients. In various embodiments, each of the packets on which the generated aggregate packet is based are destined for clients within the same ISP.

At block 612, the generated aggregate packet is sent to a remote server. In some embodiments, the generated aggregate packet is sent to a CDN edge node. In certain embodiments, the CDN edge node is included within the same ISP as the clients associated with the generated aggregate packet.

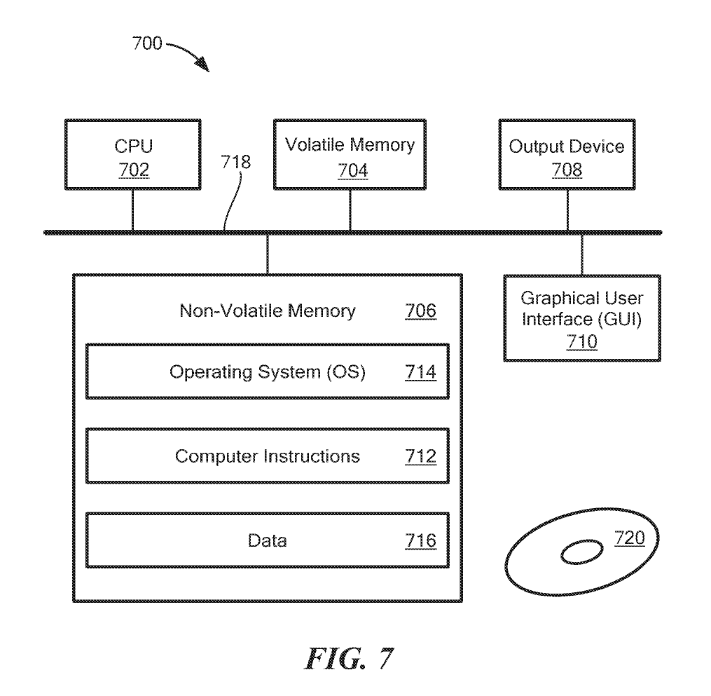

FIG. 7 shows an illustrative computer 700 that can perform at least part of the processing described herein, according to an embodiment of the disclosure. The computer 700 may include a processor 702, a volatile memory 704, a non-volatile memory 706 (e.g., hard disk), an output device 708 and a graphical user interface (GUI) 710 (e.g., a mouse, a keyboard, a display, for example), each of which is coupled together by a bus 718. The non-volatile memory 706 may be configured to is store computer instructions 712, an operating system 714, and data 716. In one example, the computer instructions 712 are executed by the processor 702 out of volatile memory 704. In some embodiments, the computer 700 corresponds to a virtual machine (VM). In other embodiments, the computer 700 corresponds to a physical computer.

In some embodiments, a non-transitory computer-readable medium 720 may be provided on which a computer program product may be tangibly embodied. The non-transitory computer-readable medium 720 may store program instructions that are executable to perform processing described herein.

Referring again to FIG. 7, processing may be implemented in hardware, software, or a combination of the two. In various embodiments, processing is provided by computer programs executing on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage is medium or device is read by the computer. Processing may also be implemented as a machine-readable storage medium, configured with a computer program, where upon execution, instructions in the computer program cause the computer to operate. The program logic may be run on a physical or virtual processor. The program logic may be run across one or more physical or virtual processors.

Processing may be performed by one or more programmable processors executing one or more computer programs to perform the functions of the system. All or part of the system may be implemented as special purpose logic circuitry (e.g., an FPGA (field programmable gate array) and/or an ASIC (application-specific integrated circuit)).

Additionally, the software included as part of the concepts, structures, and techniques sought to be protected herein may be embodied in a computer program product that includes a computer-readable storage medium. For example, such a computer-readable storage medium can include a computer-readable memory device, such as a hard drive device, a CD-ROM, a DVD-ROM, or a computer diskette, having computer-readable program code segments stored thereon. In contrast, a computer-readable transmission medium can include a communications link, either optical, wired, or wireless, having program code segments carried thereon as digital or analog signals. A non-transitory machine-readable medium may include but is not limited to a hard drive, compact disc, flash memory, non-volatile memory, volatile memory, magnetic diskette and so forth but does not include a transitory signal per se.

All references cited herein are hereby incorporated herein by reference in their entirety.

Having described certain embodiments, which serve to illustrate various concepts, structures, and techniques sought to be protected herein, it will be apparent to those of ordinary skill in the art that other embodiments incorporating these concepts, structures, and techniques may be used. Elements of different embodiments described hereinabove may be combined to form other embodiments not specifically set forth above and, further, elements described in the context of a single embodiment may be io provided separately or in any suitable sub-combination. Accordingly, it is submitted that the scope of protection sought herein should not be limited to the described embodiments but rather should be limited only by the spirit and scope of the following claims.

What is claimed is:

1. A method for vertical packet aggregation in a client-server system, the method comprising:
receiving packets from a plurality of clients;
generating an aggregate packet having a copy of the payload of two or more of the packets received from different ones of the plurality of clients within a common buffer period; and
sending the generated aggregate packet to a remote server.

2. The method of claim 1 wherein receiving packets from a plurality of clients comprises receiving packets at a node within a distributed network.

3. The method of claim 2 wherein receiving packets from a plurality of clients comprises receiving packets at an edge node within a content delivery network (CDN).

4. The method of claim 1 wherein sending the generated aggregate packet to the remote server comprises sending the generated aggregate packet to a peer node within a distributed network.

5. The method of claim 1 wherein sending the generated aggregate packet to the remote server comprises sending the generated aggregate packet to an ingest server within the CDN.

6. The method of claim 1 wherein generating the aggregate packet comprises generating an aggregate packet having metadata to associate each payload copy with one of the plurality of clients.

7. The method of claim 1 wherein generating the aggregate packet comprises generating an aggregate packet having a copy of payloads from client packets destined for one or more of the same remote servers.

8. The method of claim 1 wherein generating the aggregate packet comprises generating an aggregate packet having a copy of at most one payload from each of the plurality of clients.

9. The method of claim 1 wherein receiving packets from a plurality of clients comprises receiving packets comprising multiplayer game data.

10. The method of claim 1 wherein receiving packets from a plurality of clients comprises receiving packets Internet of Things (IoT) data.

11. The method of claim 1 wherein receiving packets from a plurality of clients includes receiving packets from clients associated with two or more different applications.

12. The method of claim 1 further comprising:
processing one or more of the received packets.

13. The method of claim 12 wherein processing the one or more received packets includes compressing data within the one or more received packets.

14. The method of claim 12 wherein processing the one or more received packets includes encrypting data within the one or more received packets.

15. The method of claim 12 wherein processing the one or more received packets includes augmenting data within the one or more received packets.

16. The method of claim 12 wherein processing the one or more received packets includes filtering the one or more of the received packets.

17. The method of claim 1 wherein receiving packets from a plurality of clients includes receiving packets using at least two different protocols.

18. The method of claim 1 further comprising:
selecting the two or more packets based on the order packets were received from the clients.

19. The method of claim 1 further comprising:
selecting the two or more packets based on priority levels associated with ones of the plurality of clients.

20. The method of claim 1 further comprising:
storing the packets received from a plurality of clients; and
regenerating and resending the aggregate packet using the stored packets.

21. The method of claim 20 wherein storing the packets received from a plurality of clients includes storing packets for more than one hour.

22. The method of claim 1 wherein receiving packets from a plurality of clients includes receiving a multicast packet from a client.

23. The method of claim 1 wherein sending the generated aggregate packet to a remote server includes sending a multicast packet having a multicast group id associated with the remote server.

24. A system comprising:
a processor;
a volatile memory; and
a non-volatile memory storing computer program code that when executed on the processor causes the processor to execute a process operable to:
receiving packets from a plurality of clients;
generating an aggregate packet having a copy of the payload of two or more of the packets received from different ones of the plurality of clients within a common buffer period; and
sending the generated aggregate packet to a remote server.
